(19) United States
(12) Patent Application Publication
(10) Pub. No.: US 2017/0316678 A1
(43) Pub. Date: Nov. 2, 2017

(54) ANTI-JAMMING ALARM SECURITY SYSTEM

(71) Applicant: Brian DeAngelo, St. Charles, IL (US)

(72) Inventor: Brian DeAngelo, St. Charles, IL (US)

(21) Appl. No.: 15/445,292

(22) Filed: Feb. 28, 2017

Related U.S. Application Data
(60) Provisional application No. 62/329,023, filed on Apr. 28, 2016.

(51) Int. Cl. G08B 25/10; G08B 25/00

(52) U.S. Cl. CPC G08B 25/10; G08B 25/008

(57) ABSTRACT

The alarm security system is provided. The alarm security system includes a detector. The detector may be situated near a door or window of a building and may detect a breach within the area, such as a building. The present invention further includes an emitter operable to produce a trigger signal. The trigger signal is at least one of a sound and a light. The trigger signal is produced by the emitter when the detector detects the breach within the area. A receiver is operable to receive the trigger signal. A transmitter is operable to transmit a communication to a remote alarm monitoring center when the receiver receives the trigger signal.

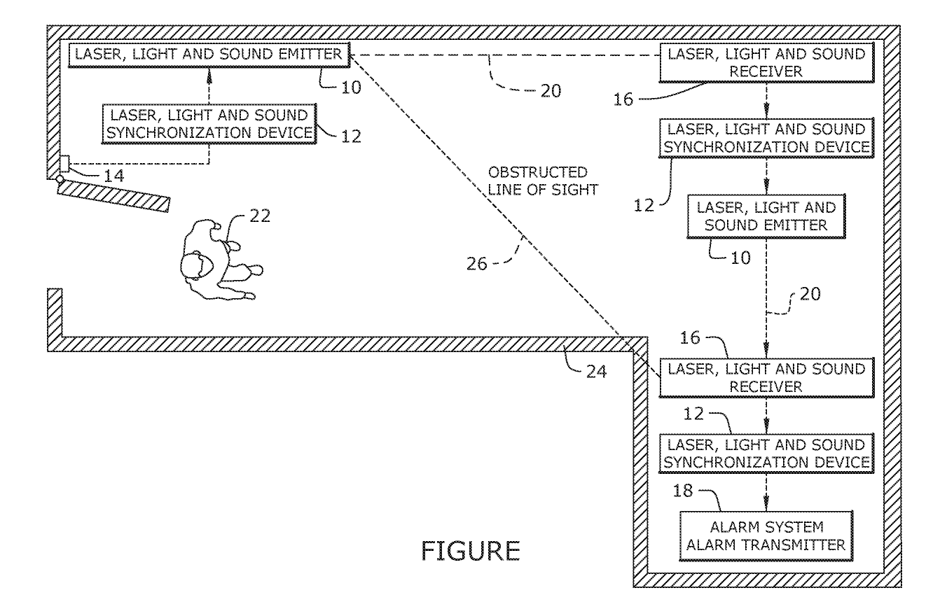

### CROSS-REFERENCE TO RELATED APPLICATION

This application claims the benefit of priority of U.S. provisional application No. 62/329,023, filed Apr. 28, 2016, the contents of which are herein incorporated by reference.

### BACKGROUND OF THE INVENTION

The present invention relates to an alarm security system and, particularly, to the alarm security system that uses at least one type of light that may also be accompanied by sound to activate an alarm.

A security alarm is a system designed to detect intrusion into a building or area. Security alarms are used to protect residential, commercial, industrial, and military properties for protection against burglary or property damage, as well as personal protection against intruders.

Current home and business alarm security systems may be wired or wireless. One of the main concerns of a home alarm security system is whether or not a given system is vulnerable to being circumvented from working altogether by an intruder. With wired alarm system setups, the fear is that a burglar can circumvent the alarm system, simply by cutting the right cable.

With a wireless alarm system setup, battery-powered sensors are setup around the home or business to detect intrusion within the protected area. If they detect something amiss while the system is armed, the alarm system sensors transmit a wireless alert signal to the alarm system's wireless alarm component receiver that will then raise the alarm. The wireless approach eliminates the possibility of a burglar cutting the right cable. However, burglars may use a frequency jamming device that is tuned to the frequency that the alarm system is functioning on, which jams the frequency signal and blocks/jams the wireless alarm sensor's radio signal from being received by the alarm system's wireless alarm component receiver. The wireless alarm component receiver is sometimes installed in to the alarm system's base station.

As can be seen, there is a need for a system and method of preventing intruders from circumventing an alarm security system.

### SUMMARY OF THE INVENTION

In one aspect of the present invention, an alarm security system comprising: a detector operable to detect an intrusion within a protected area such as within a building; an emitter operable to produce a trigger signal comprising of one or more types of sound(s) that may also be accompanied by light(s), when the detector detects intrusion within the protected area or within the protected building; a receiver operable to receive the trigger signal; and a transmitter operable to transmit a communication to a remote alarm monitoring center when the receiver receives the trigger signal.

In another aspect of the present invention, a method of detecting an intruder within a building comprises of alarm sensors and detectors within the building; producing a trigger signal comprising at least one of sound and light from an emitter when the motion detector detects a motion within the building; receiving the trigger signal by a receiver; and transmitting a communication to a remote alarm monitoring center by a transmitter after the receiver receives the trigger signal.

These and other features, aspects and advantages of the present invention will become better understood by referencing the following drawings, description and claims.

### BRIEF DESCRIPTION OF THE DRAWINGS

The FIGURE is a schematic view of an embodiment of the present invention.

### DETAILED DESCRIPTION OF THE INVENTION

The following detailed description represents the best currently contemplated modes of carrying out exemplary embodiments of the invention. The description is not to be taken in a limiting sense, but is made merely to illustrate the general principles of the invention, since the scope of the invention is best defined by the appended claims.

The present invention includes a wireless alarm system that includes an activation notification utilizing light and sound. The present invention utilizes one or more sound(s) and/or light(s), such as a laser, instead of a radio frequency to prevent a person from interfering or jamming the communication. The present invention can be used to communicate with devices or systems by using light and/or sound, directing the devices and systems to perform any one or more functions such as arm, disarm, turn on, turn off, unlock and lock.

When the wireless alarm component is activated/triggered, then the alarm component emits one or more of a laser, light and/or sound. Then the wireless alarm system alarm transmitter receives the laser, light and/or sound from the wireless alarm component. The alarm transmitter will use the synchronizing device to verify that the laser, light and/or sound that was received have originated from an authorized wireless alarm component. If it is verified that the laser, light and/or sound had originated from an authorized wireless or wired alarm component, the alarm transmitter transmits an alarm signal to the alarm monitoring center.

Referring to the FIGURE, the present invention includes an alarm security system. The alarm security system includes a detector 14. The detector 14 may be situated anyplace within a protected area 24 and will detect intrusion. The present invention may include an emitter 10 operable to produce a trigger signal 20. The trigger signal 20 is at least one of a sound and a light. The light may be in the form of a laser. The trigger signal is produced by the emitter 10 when the detector 14 detects the motion of an intruder 22 within the protected building or other protected area 24. A receiver 16 is operable to receive the trigger signal 20. A transmitter 18 is operable to transmit a communication to a remote alarm monitoring center when the receiver 16 receives the trigger signal 20.

Alternatively, the trigger signal may be constantly produced by the emitter 10. When the detector 14 detects an intruder 22 within the protected area 24, the emitter stops producing the trigger signal. Once the receiver 16 no longer receives the trigger signal 20 the transmitter 18 is operable to transmit a communication to a remote alarm monitoring center identifying a breach.

The present invention may further include a synchronizer 12. The synchronizer 12 is operable to synchronize the trigger signal 20 to form a synchronized trigger signal 20. The emitter 10 is operable to produce the synchronized trigger signal 20. The receiver 16 is operable to only recognize the synchronized trigger signal 20 and therefore can verify that the synchronized trigger signal originated from a verified emitter 10. The synchronization may be in the form of a sound wave, light wave, light activation patterns and the like. If the emitted sound and/or light matches the particular sound wave, light wave, and light activation pattern that is synchronized with the synchronization device, the transmitter 18 transmits the communication to the alarm monitoring system.

The present invention may include a detector 14 or a plurality of detectors 14. The detectors 14 may be a passive infrared motion detector. The term passive refers to the fact that the detector does not generate or radiate its own energy; it works entirely by detecting the heat energy given off by an intruder or other heat generating objects such as a vehicle's engine.

The detectors 14 may be motion sensors. Motion sensors are devices that use various forms of technology to detect movement. The technology typically found in motion sensors to trigger an alarm includes infrared, ultrasonic, vibration and contact. Dual technology sensors combine two or more forms of detection in order to reduce false alarms. Motion detectors are typically installed to cover a large area as they commonly cover up to 40 ft with a 135° field of vision.

The detectors 14 may include a glass break detector. The glass break detector may be used for internal perimeter building protection. Glass break acoustic detectors are mounted near the glass panes and listen for sound frequencies associated with glass breaking.

The detectors 14 may include a hermetically sealed reed switch, which is a two-piece sensor that operates with an electrically conductive reed switch that is either normally open or normally closed when under the influence of a magnetic field as in the case of proximity to the second piece which contains a magnet. When the magnet is moved away from the reed switch, the reed switch either closes or opens, again based on the original set point. This action coupled with an electric current (typically at 12 V DC) detects a fault on that zone or circuit.

As mentioned above, the transmitter 18 transmits the communication a to a remote alarm monitoring center. The transmitter 18 may transmit the communication over telecommunications networks, such as, but not limited to, global system for mobile communication (GSM) or radio. Further, the transmitter 18 may include a jam detection unit operable to detect whether the signal is being jammed. If the jam detection unit detects a jammed signal, an alternate signal is sent to the remote alarm monitoring center from the transmitter 18.

The receiver 16, the transmitter 18 and the synchronizer 12 may be separate from one another or may be part of the same unit. For example, the present invention may include a control unit. The control unit may house the receiver 16, the transmitter 18 and the synchronizer 12. The user may control the alarm security system using the control unit by turning the control unit on and off. Further, the user may synchronize the trigger signal 20 via the control unit.

In certain embodiments, the control unit may further include a global positioning system (GPS) unit. The detectors 14 may each include a GPS coordinates reporting device. The global positioning system (GPS) device will have an identification number to identify the global positioning system (GPS) device from another global positioning system (GPS) device. When the alarm system is being armed, the GPS devices report their current GPS coordinates. Then after the alarm system is armed 14 the global positioning system (GPS) device may constantly communicate via a transmission method the current GPS device's identification number and the current the global positioning system (GPS) coordinates of the global positioning system (GPS) device. The alarm system may cross reference the current global positioning system (GPS) coordinates with the global positioning system (GPS) coordinates that was captured and stored by the alarm system to ensure that the global positioning system (GPS) coordinates device is at the same location as it was located at, when the alarm system was being armed. If the alarm system determines that the global positioning system (GPS) device's global positioning system (GPS) coordinates have changed after the alarm system have been armed, then the alarm system will be triggered/activated. Therefore, if a detector 14 is tampered with or is moved, the alarm system is triggered/activated. At least one notification is sent via at least one communication method such as email, text message and phone call, to a smart phone device.

The receiver 16 of the present invention is further capable of receiving an obstructed trigger signal 26. In such embodiments, the room may be setup with multiple receivers 16 and emitters 10 as illustrated in the Figure. Therefore, the detector 14 may detect a breach and a first emitter 10 sends the trigger signal 20 to a first receiver 16. The first receiver 16 determines that the trigger signal 20 is the synchronized trigger signal 20 and then a second emitter 10 send the trigger signal 20 to a second receiver 16. The second receiver 16 is in direct communication with the transmitter 18. The second receiver 16 determines that the trigger signal 20 is the synchronized trigger signal 20 and activates the transmitter 18.

The present invention further includes a method of detecting an intruder within a protected area. The method may include alarm sensors and detectors within the area; producing a trigger signal comprising at least one of a sound and a light from an emitter when the motion detector detects a motion within the area; receiving the trigger signal by a receiver; and transmitting a communication to a remote alarm monitoring center by a transmitter after the receiver receives the trigger signal. The steps may further include: synchronizing the trigger signal to form a synchronized trigger signal using a synchronizer; verifying the synchronized trigger signal by the receiver; and transmitting an alarm signal communication to a remote alarm monitoring center via GSM or radio communication, after the synchronized trigger signal is verified to have originated from an authorized alarm component.

The intrusion detector or sensor of the present invention may receive at least one authorization signal to authorize the intrusion detector or sensor to function. If the signal is not received, then the intruder detector or sensor stops functioning. The intruder detector or sensor can also have a built-in or attached keypad, to allow at least one authorization code to be entered in to the intruder detector or sensor's built-in or attached keypad.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claim

What is claimed is:

1. An alarm security system comprising:
a detector operable to detect a breach within an area;
an emitter operable to produce a trigger signal comprising at least one of sound and a light;
a receiver operable to receive the trigger signal and identify the breach within the area; and
a transmitter operable to transmit a communication to at least one alarm monitoring center when the receiver identifies the breach.

2. The alarm system of claim 1, wherein the emitter produces the trigger signal when the detector detects the breach within the area, wherein the receiver identifies the breach when the receiver receives the trigger signal.

3. The alarm system of claim 2, further comprising:
a synchronizer operable to synchronize the trigger signal to form a synchronized trigger signal, wherein
the receiver verifies the synchronized trigger signal; and
the transmitter transmits the communication to the alarm monitoring center once the synchronized trigger signal is verified.

4. The alarm system of claim 1, wherein the light is in the form of at least one laser.

5. The alarm system of claim 1, wherein the detector further comprises a keypad operable to receive a code to arm and disarm the detector.

6. The alarm system of claim 1, wherein the emitter constantly emits the trigger signal until the detector detects the breach within the area, wherein the receiver identifies the breach when the emitter no longer emits the trigger signal.

7. A method of detecting an intruder within an area comprising the steps of:
providing a detector within an area, wherein the detector is operable to detect a breach within the area;
producing at least one trigger signal comprising at least one of a sound and a light from an emitter;
receiving the trigger signal by a receiver, wherein the receiver identifies the breach within the area; and
transmitting a communication comprising a frequency signal by a transmitter to a remote alarm monitoring center after the receiver identifies the breach.

8. The method of claim 7, wherein the emitter produces the trigger signal when the detector detects the breach within the area, wherein the receiver identifies the breach when the receiver receives the trigger signal.

9. The method of claim 8, further comprising the steps of:
synchronizing the trigger signal to form a synchronized trigger signal using a synchronizer;
verifying the synchronized trigger signal by the receiver; and
transmitting the communication to a remote alarm monitoring center by the transmitter after the synchronized trigger signal is verified.

10. The method of claim 7, wherein detector comprises a global positioning system.

11. The method of claim 10, further comprising the step of triggering the alarm system if the global positioning coordinate device is moved from the location, and sending at least one notification by phone, text or email to a remote smart device.

12. The method of claim 7, wherein the emitter constantly emits the trigger signal until the detector detects the breach within the area, wherein the receiver identifies the breach when the emitter no longer emits the trigger signal.
